(19) United States
(12) Patent Application Publication
(10) Pub. No.: US 2023/0360048 A1
(43) Pub. Date: Nov. 9, 2023

(54) SYSTEMS AND METHOD FOR FRAUD DETECTION BASED ON CHANGES IN POSTED DATA WITH TIERED CODE RESPONSE DEPLOYMENT

(71) Applicant: BANK OF AMERICA CORPORATION, Charlotte, NC (US)

(72) Inventors: George Anthony Albero, Charlotte, NC (US); Jake Michael Yara, Mint Hill, NC (US); Dustin Paul Stocks, Stallings, NC (US); Edward Lee Traywick, Bellbrook, OH (US)

(73) Assignee: BANK OF AMERICA CORPORATION, Charlotte, NC (US)

(21) Appl. No.: 17/736,460

(22) Filed: May 4, 2022

(51) Int. Cl. G06Q 20/40; G06F 21/55; G06F 21/62

(52) U.S. Cl. CPC G06Q 20/4016; G06F 21/554; G06F 21/629

(57) ABSTRACT

Embodiments of the invention are directed to systems, methods, and computer program products for fraud detection based on changes in resource transmissions. The invention is configured to identify unauthorized resource transmission by importing or retrieving data known to have been associated with unauthorized resource transmissions to project one or more patterns of unauthorized resource transmission that can be compared with resource transmission data of a user to identify a potentially misappropriated transaction.

### BACKGROUND

Bad actors are continually developing methods for conducting unauthorized transmissions of resources without detection. One such method is using a withdrawal pattern that requires an initial withdrawal to validate the account, then transmitting a larger withdrawal once the account is validated. Alternatively or additionally, the bad actor may increase each subsequent unauthorized withdrawal with each subsequent transmission.

While this unauthorized transmission may be difficult for a user to identify, these transmissions often follow a pattern that can be identified by analyzing aggregated transmission data related to accounts that are known to have been accessed by an unauthorized user.

Therefore, a need exists to identify patterns associated with unauthorized resource transmission patterns and trigger a response that will allow protection of the user.

### SUMMARY

The following presents a simplified summary of one or more embodiments of the present invention, in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments of the present invention in a simplified form as a prelude to the more detailed description that is presented later.

In some embodiments, the invention may comprise a system, method, and computer program product for detecting unauthorized changes in activity data, wherein the system is structured for maintaining security of activity data and preventing unauthorized access, the system comprising: a memory device with computer-readable program code stored thereon; a communication device; a processing device operatively coupled to the memory device and the communication device, wherein the processing device is configured to execute the computer-readable program code to: import or retrieve data from a database, the database comprising unintended user resource transmission data; process the database to develop one or more projected patterns of unintended user resource transmission; import resource transmission data associated with a first user, identify suspect patterns within the resource transmission data associated with a first user, and execute a detection action in response to identification of suspect patterns within the resource transmission data associated with a first user.

In some embodiments, the steps of importing resource transmission data associated with a first user, identifying suspect patterns within the resource transmission data associated with a first user, and executing a detection may be repeated one or more times. In some such embodiments, the detection action changes when the steps are repeated.

In some embodiments, one or more projected patterns of unintended user resource transmission comprise a status validation resource withdrawal.

In some embodiments, the processing device is further configured to execute the computer-readable program code to import resource transmission data associated with a first user from two or more user resource accounts.

In some embodiments, the step of identifying suspect patterns within the resource transmission data associated with a first user comprises identifying a current activity associated with a resource transmission of the first user, analyzing the current activity to determine if the current activity is associated with a suspect pattern.

In certain embodiments, the detection action comprises transmitting a signal to an entity device to cause it to block or modify the current activity prior to completion.

In certain embodiments, the detection action comprises notifying a user or institution associated with the user's account. In such embodiments, the detection action may further comprise accepting a user input and executing a user-initiated action. In some such embodiments, the user input denies the validity of the resource transmission data associated with a first user. In those embodiments, the user-initiated action may comprise increasing the severity of the detection action, decreasing the severity of the detection action, limiting or prohibiting resource transmission, notifying an institution associated with a user's resource account, or any combination thereof.

### BRIEF DESCRIPTION OF THE DRAWINGS

Having thus described embodiments of the invention in general terms, reference will now be made to the accompanying drawings, where:

FIG. 1 illustrates a system environment configured to detect unauthorized changes in activity data, in accordance with embodiments of the present invention;

FIG. 2 illustrates a flowchart for developing projected patterns of unintended user transmission data and detecting unauthorized changes in resource transmission data in order to execute a detection action; and

FIG. 3 illustrates a flowchart for executing a detection action.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, a “user” may be an employee (e.g., an associate, a software code developer, a project manager, an IT specialist, a manager, an administrator, an internal operations analyst, or the like) of the entity or enterprises affiliated with the entity, capable of operating the systems described herein. In some embodiments, a “user” may be any individual, entity or system who has a relationship with the entity, such as a customer or a prospective customer. In other embodiments, a user may be a system performing one or more tasks described herein. Those having skill in the art will recognize that a user is not limited a natural person nor is a user limited to a legal person. A user can be defined as a person, computer, entity, software system, and the like. Further, the term “user” can refer to more than one person, computer, entity, software system, and the like and is not limited to a single user.

As used herein, a “user interface” may be any device or software that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices to input data received from a user second user or output data to a user. These input and output devices may include a display, mouse, keyboard, button, touchpad, touch screen, microphone, speaker, LED, light, joystick, switch, buzzer, bell, and/or other user input/output device for communicating with one or more users.

As used herein, an “engine” may refer to core elements of a computer program, or part of a computer program that serves as a foundation for a larger piece of software and drives the functionality of the software. An engine may be self-contained, but externally-controllable code that encapsulates powerful logic designed to perform or execute a specific type of function. In one aspect, an engine may be underlying source code that establishes file hierarchy, input and output methods, and how a specific part of a computer program interacts or communicates with other software and/or hardware. The specific components of an engine may vary based on the needs of the specific computer program as part of the larger piece of software. In some embodiments, an engine may be configured to retrieve resources created in other computer programs, which may then be ported into the engine for use during specific operational aspects of the engine. An engine may be configurable to be implemented within any general purpose computing system. In doing so, the engine may be configured to execute source code embedded therein to control specific features of the general purpose computing system to execute specific computing operations, thereby transforming the general purpose system into a specific purpose computing system.

As used herein, an “interaction” may refer to any communication between one or more users, one or more entities or institutions, and/or one or more devices, nodes, clusters, or systems within the system environment described herein. For example, an interaction may refer to a transfer of data between devices, an accessing of stored data by one or more nodes of a computing cluster, a transmission of a requested task, or the like.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

As used herein, an “intended user” is a user who is not the owner or an otherwise authorized user of a resource account.

As used herein, an “unintended user resource transmission” is a resource withdrawal initiated by an unauthorized or otherwise unintended user.

As used herein, a “status validation resource withdrawal” is a resource transmission having characteristics that are known by those having skill in the art to suggest that the resource withdrawal was initiated by an unauthorized user to determine a status of a resource account.

As used herein, “posted data” is data that has been posted to one or more of a user's resource accounts. While one having skill in the art will realize that “posted data” is not limited to transmission data, the term is used throughout to discuss withdrawal data in addition to other types of posted data.

As used herein, “suspect patterns” are patterns that have been identified within the posted data that match those found in the one or more projected patterns of unauthorized resource transmission.

As used herein, “a detection action” is an action that is taken in response to identifying suspect patterns in the analyzed data.

As used herein, “a user-initiated action” is an action that is taken in response to input from a user.

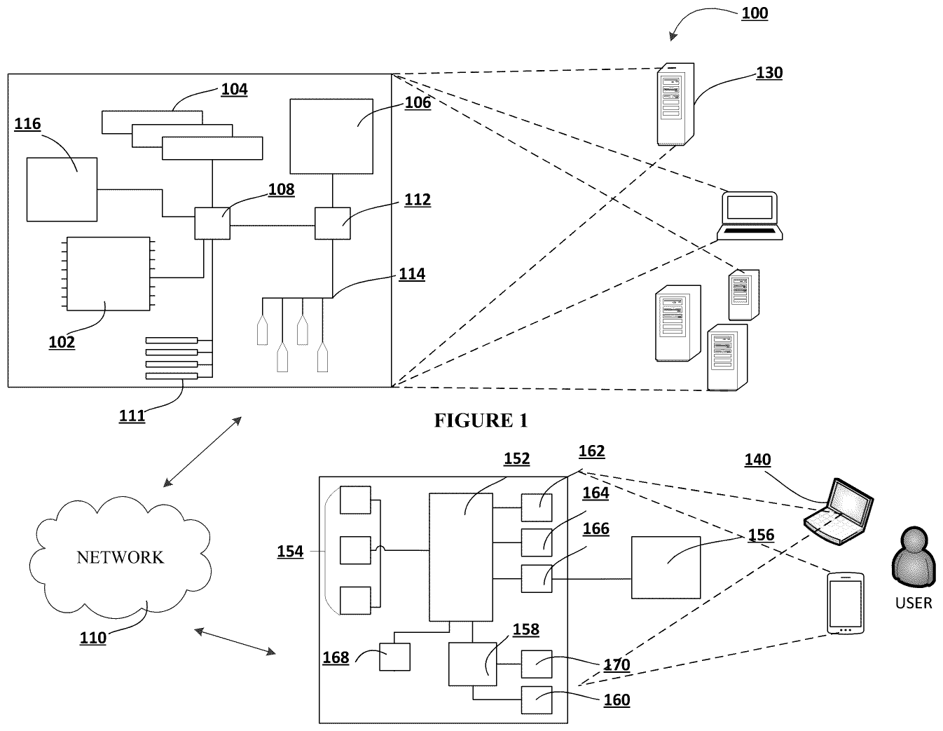

FIG. 1 illustrates a multi-device functional code logic for multiple device communication 100, in accordance with an embodiment of the invention. FIG. 1 provides a unique system that includes specialized servers and system communicably linked across a distributive network of nodes required to perform the functions of the process flows described herein in accordance with embodiments of the present invention.

As illustrated, the system environment 100 includes a network 110, a system 130, and a user input device 140. In some embodiments, the system 130, and the user input device 140 may be used to implement the processes described herein, in accordance with an embodiment of the present invention. In this regard, the system 130 and/or the user input device 140 may include one or more applications stored thereon that are configured to interact with one another to implement any one or more portions of the various user interfaces and/or process flow described herein.

In accordance with embodiments of the invention, the system 130 is intended to represent various forms of digital computers, such as laptops, desktops, video recorders, audio/video player, radio, workstations, servers, wearable devices, Internet-of-things devices, electronic kiosk devices (e.g., automated teller machine devices), blade servers, mainframes, or any combination of the aforementioned. In accordance with embodiments of the invention, the user input device 140 is intended to represent various forms of mobile devices, such as personal digital assistants, cellular telephones, smartphones, augmented reality (AR) devices, virtual reality (VR) devices, extended reality (XR) devices, and other similar computing devices. The components shown here, their connections and relationships, and their functions, are meant to be exemplary only, and are not meant to limit implementations of the inventions described and/or claimed in this document.

In accordance with some embodiments, the system 130 may include a processor 102, memory 104, a storage device 106, a high-speed interface 108 connecting to memory 104, and a low-speed interface 112 connecting to low speed bus 114 and storage device 106. Each of the components 102, 104, 106, 108, 111, and 112 are interconnected using various buses, and may be mounted on a common motherboard or in other manners as appropriate. The processor 102 can process instructions for execution within the system 130, including instructions stored in the memory 104 or on the storage device 106 to display graphical information for a GUI on an external input/output device, such as display 116 coupled to a high-speed interface 108. In other implementations, multiple processors and/or multiple buses may be used, as appropriate, along with multiple memories and types of memory. Also, multiple systems, same or similar to system 130 may be connected, with each system providing portions of the necessary operations (e.g., as a server bank, a group of blade servers, or a multi-processor system). In some embodiments, the system 130 may be a server managed by the business. The system 130 may be located at the facility associated with the business or remotely from the facility associated with the business.

The memory 104 stores information within the system 130. In one implementation, the memory 104 is a volatile memory unit or units, such as volatile random access memory (RAM) having a cache area for the temporary storage of information. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like. The memory 104 may store any one or more of pieces of information and data used by the system in which it resides to implement the functions of that system. In this regard, the system may dynamically utilize the volatile memory over the non-volatile memory by storing multiple pieces of information in the volatile memory, thereby reducing the load on the system and increasing the processing speed.

The storage device 106 is capable of providing mass storage for the system 130. In one aspect, the storage device 106 may be or contain a computer-readable medium, such as a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer- or machine-readable storage medium, such as the memory 104, the storage device 104, or memory on processor 102.

In some embodiments, the system 130 may be configured to access, via the network 110, a number of other computing devices (not shown) in addition to the user input device 140. In this regard, the system 130 may be configured to access one or more storage devices and/or one or more memory devices associated with each of the other computing devices. In this way, the system 130 may implement dynamic allocation and de-allocation of local memory resources among multiple computing devices in a parallel or distributed system. Given a group of computing devices and a collection of interconnected local memory devices, the fragmentation of memory resources is rendered irrelevant by configuring the system 130 to dynamically allocate memory based on availability of memory either locally, or in any of the other computing devices accessible via the network. In effect, it appears as though the memory is being allocated from a central pool of memory, even though the space is distributed throughout the system. This method of dynamically allocating memory provides increased flexibility when the data size changes during the lifetime of an application and allows memory reuse for better utilization of the memory resources when the data sizes are large.

The high-speed interface 108 manages bandwidth-intensive operations for the system 130, while the low speed controller 112 manages lower bandwidth-intensive operations. Such allocation of functions is exemplary only. In some embodiments, the high-speed interface 108 is coupled to memory 104, display 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms, as shown in FIG. 1. For example, it may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1 also illustrates a user input device 140, in accordance with an embodiment of the invention. The user input device 140 includes a processor 152, memory 154, an input/output device such as a display 156, a communication interface 158, and a transceiver 160, among other components. The user input device 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the user input device 140, including instructions stored in the memory 154. The processor may be implemented as a chipset of chips that include separate and multiple analog and digital processors. The processor may be configured to provide, for example, for coordination of the other components of the user input device 140, such as control of user interfaces, applications run by user input device 140, and wireless communication by user input device 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of user input device 140 with other devices. External interface 168 may provide, for example, for wired communication in some implementations, or for wireless communication in other implementations, and multiple interfaces may also be used.

The memory 154 stores information within the user input device 140. The memory 154 can be implemented as one or more of a computer-readable medium or media, a volatile memory unit or units, or a non-volatile memory unit or units. Expansion memory may also be provided and connected to user input device 140 through an expansion interface (not shown), which may include, for example, a SIMM (Single In Line Memory Module) card interface. Such expansion memory may provide extra storage space for user input device 140 or may also store applications or other information therein. In some embodiments, expansion memory may include instructions to carry out or supplement the processes described above and may include secure information also. For example, expansion memory may be provided as a security module for user input device 140 and may be programmed with instructions that permit secure use of user input device 140. In addition, secure applications may be provided via the SIMM cards, along with additional information, such as placing identifying information on the SIMM card in a non-hackable manner. In some embodiments, the user may use the applications to execute processes described with respect to the process flows described herein. Specifically, the application executes the process flows described herein.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer-or machine-readable medium, such as the memory 154, expansion memory, memory on processor 152, or a propagated signal that may be received, for example, over transceiver 160 or external interface 168.

In some embodiments, the user may use the user input device 140, such as a wearable device, to transmit and/or receive information or commands to and from the system 130 via the network 110. Any communication between the system 130 and the user input device 140 (or any other computing devices) may be subject to an authentication protocol allowing the system 130 to maintain security by permitting only authenticated users (or processes) to access the protected resources of the system 130, which may include servers, databases, applications, and/or any of the components described herein. To this end, the system 130 may require the user (or process) to provide authentication credentials to determine whether the user (or process) is eligible to access the protected resources. Once the authentication credentials are validated and the user (or process) is authenticated, the system 130 may provide the user (or process) with permissioned access to the protected resources. Similarly, the user input device 140 (or any other computing devices) may provide the system 130 with permissioned to access the protected resources of the user input device 130 (or any other computing devices), which may include a GPS device, an image capturing component (e.g., camera), a microphone, a speaker, and/or any of the components described herein.

The user input device 140 may communicate with the system 130 (and one or more other devices) wirelessly through communication interface 158, which may include digital signal processing circuitry where necessary. Communication interface 158 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 160. In addition, short-range communication may occur, such as using a Bluetooth, Wi-Fi, or other such transceiver (not shown). In addition, GPS (Global Positioning System) receiver module 170 may provide additional navigation- and location-related wireless data to user input device 140, which may be used as appropriate by applications running thereon, and in some embodiments, one or more applications operating on the system 130.

The user input device 140 may also communicate audibly using audio codec 162, which may receive spoken information from a user and convert it to usable digital information. Audio codec 162 may likewise generate audible sound for a user, such as through a speaker, e.g., in a handset of user input device 140. Such sound may include sound from voice telephone calls, may include recorded sound (e.g., voice messages, music files, etc.) and may also include sound generated by one or more applications operating on the user input device 140, and in some embodiments, one or more applications operating on the system 130.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a technical environment that includes a back end component (e.g., as a data server), that includes a middleware component (e.g., an application server), that includes a front end component (e.g., a client computer having a graphical user interface or a Web browser through which a user can interact with an implementation of the systems and techniques described here), or any combination of such back end, middleware, or front end components.

As shown in FIG. 1, the components of the system 130 and the user input device 140 are interconnected using the network 110. The network 110, which may be include one or more separate networks, be a form of digital communication network such as a telecommunication network, a local area network (“LAN”), a wide area network (“WAN”), a global area network (“GAN”), the Internet, or any combination of the foregoing. It will also be understood that the network 110 may be secure and/or unsecure and may also include wireless and/or wired and/or optical interconnection technology.

It will be understood that the embodiment of the system environment 100 illustrated in FIG. 1 is exemplary and that other embodiments may vary. As another example, in some embodiments, the system environment may include more, fewer, or different components. As another example, in some embodiments, some or all of the portions of the system environment 100 may be combined into a single portion. Likewise, in some embodiments, some or all of the portions of the system 130 may be separated into two or more distinct portions.

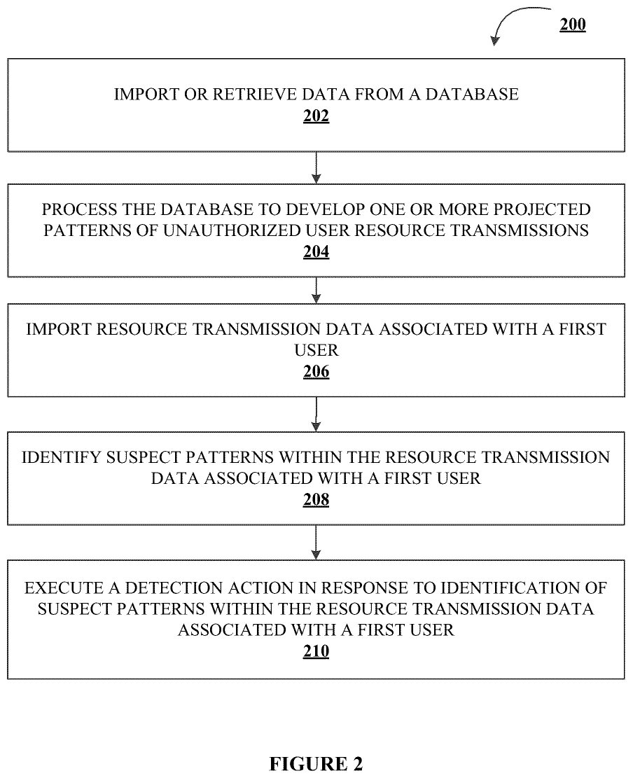

FIG. 2 illustrates a flowchart for developing projected patterns of unauthorized user transmission data and detecting unauthorized changes in resource transmission data in order to execute a detection action.

With reference to FIG. 2, the invention is configured to first import or retrieve data from a database, as shown in Step 202. The database comprises resource transmission data that was posted to accounts known to have been accessed by an unauthorized user. The data comprising resource transmission amounts, time of resource transmissions, incremental changes in resource transmission over a period of time, entities involved in resource transmissions, entities benefiting from resource transmission, location of resource transmissions, or any combination thereof may be included in the database. The data from the accounts may have been identified by the authorized user or by the controlling entity. Preferably, the database would contain data that has been anonymized and aggregated in order to provide data security and protection to all users. Additionally or alternatively, the database may contain only that data which has been identified as unauthorized by the authorized user.

The invention is further configured to process the database to develop one or more projected patterns of unauthorized user resource transmissions, as shown in Step 204. Such patterns may include status validation resource withdrawals, incremental increases in resource withdrawals, resource transmissions in locations that are not standard for the authorized user, resource transmissions over a threshold limit that can be set by the user, the entity, or identified based on prior user transmission data, and the like.

As shown in Step 206, the invention may then import transmission data associated with a user. The data may comprise resource transmission amounts, time of resource transmissions, incremental changes in resource transmission over a period of time, entities involved in resource transmissions, entities benefiting from resource transmission, location of resource transmissions, or any combination thereof may be included in the database.

Next, the invention is configured to identify suspect patterns within the resource transmission data, Step 208. This is achieved by comparing the resource transmission data of the user with the patterns of unauthorized resource transmission data projected based upon the database containing data from accounts known to have been accessed by an unauthorized user. Optionally, this step can be approached in two discreet steps. The first of which being identifying a current activity associated with a resource transmission of a first user. The current activity may be related to a retail purchase, direct transmission of resources via an application on a user device, an IP address of a device initiating the recourse transmission, and other such activity information. The second discreet step is to analyze the current activity to determine if it is associated with a with one of the projected patterns of unauthorized user resource transmission. If it is determined that the current activity is consistent with one or more of the projected patterns of unauthorized resource transmissions, then the resource transmission can be identified as suspect.

If it is determined that a suspect pattern is contained within the user data, the invention is configured to execute a detection action, 208.

One having ordinary skill in the art will recognize that the steps 206 through 208 can be repeated continuously to provide continued protection. Further, the detection action of Step 208 does not have to be the same with each additional step. The detection action may increase in severity with continued identification of potentially unauthorized transactions. For example, the first time that an unauthorized transmission is identified, the detection action 208 may comprise notifying a user of the account of the transmission whereas the second identification may comprise placing a upper-limit on resource transmission values until the validity of the resource transmission patterns are verified.

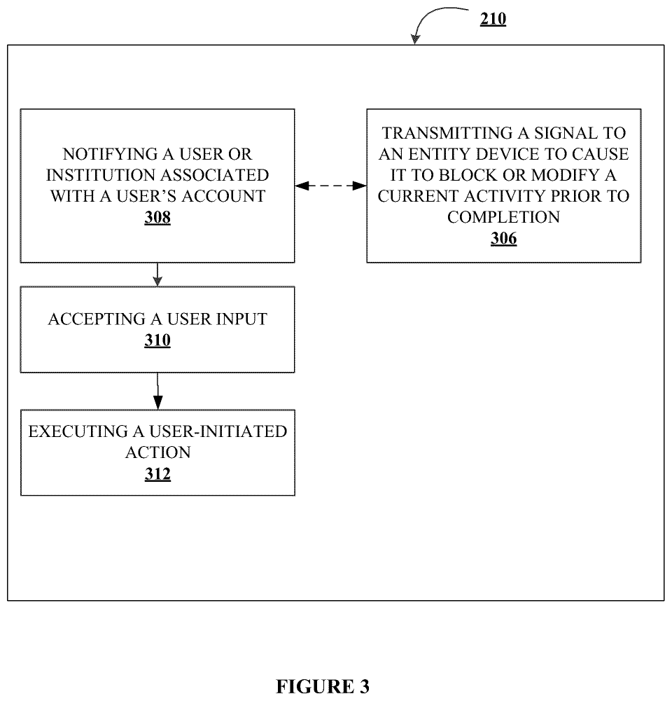

With reference to FIG. 3, the detection 208 action may comprise transmitting a signal to an entity device to cause it to block or modify a current activity prior to the activity being completed, 306. Additionally, or alternatively, the detection action may comprise three steps. The first step is notifying a user or institution associated with a user's account 308. The user may be notified via text message, phone call, email, device application notification, and other such methods that would provide notice to the user. The second step is accepting an input from the user 310. The user input may comprise making a selection on the user interface of the user's device, inputting a password, providing a multi-factor authentication information, and the like. In many circumstances, the user input will relate to the validity of one or more of the resource transmissions identified as potentially unauthorized. The final step comprises executing a user-initiated action 312. The user-initiated action may comprise blocking the current activity, locking the account, placing a threshold transmission value on the account, and the like. In the event that the user confirmed the validity of the transmission, the user initiated action may comprise unlocking the account or taking no action.

Further, it should be noted that an the detection action may vary depending on the severity of the suspected unauthorized transaction.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, stored procedures in a database, or the like), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, JavaScript, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatus and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g. a memory) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

Although many embodiments of the present invention have just been described above, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. Accordingly, the terms “a” and/or “an” shall mean “one or more,” even though the phrase “one or more” is also used herein. Like numbers refer to like elements throughout.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

What is claimed is:

1. A system for detecting changes in activity data, wherein the system is structured for maintaining security of activity data and preventing access, the system comprising:
a memory device with computer-readable program code stored thereon;
a communication device;
a processing device operatively coupled to the memory device and the communication device, wherein the processing device is configured to execute the computer-readable program code to:
import or retrieve data from a database, the database comprising resource transmission data posted to accounts known to have been accessed by an unintended user;
process the database to develop one or more projected patterns of unintended user resource transmission;
import resource transmission data associated with a first user;
identify suspect patterns within the resource transmission data associated with a first user; and
execute a detection action in response to identification of suspect patterns within the resource transmission data associated with a first user.

2. The system of claim 1, wherein the steps of importing resource transmission data associated with a first user, identifying suspect patterns within the resource transmission data associated with a first user, and executing a detection may be repeated one or more times.

3. The system of claim 1, wherein the detection action changes when the steps are repeated.

4. The system of claim 1, wherein the one or more projected patterns of unintended user resource transmission comprise a status validation resource transmission.

5. The system of claim 1, wherein the processing device is further configured to execute the computer-readable program code to import resource transmission data associated with a first user from two or more user resource accounts.

6. The system of claim 1, wherein identify suspect patterns within the resource transmission data associated with a first user comprises:
identifying a current activity associated with a resource transmission of the first user; and
analyzing the current activity to determine if the current activity is associated with a suspect pattern.

7. The system of claim 1, wherein the detection action comprises:
notifying a user or institution associated with the user's account
accepting a user input; and
executing a user-initiated action.

8. The system of claim 7, wherein the detection action further comprises transmitting a signal to an entity device to cause it to block or modify the current activity prior to completion.

9. The system of claim 7, wherein the user input denies the validity of the resource transmission data associated with a first user.

10. The system of claim 8, wherein the user-initiated action comprises increasing the severity of the detection action, decreasing the severity of the detection action, limiting or prohibiting resource transmission, notifying an institution associated with a user's resource account, or any combination thereof.

11. A computer program product for detecting changes in resource transmission data associated with a first user, wherein the computer program product comprises at least one non-transitory computer-readable medium having computer-readable program code portions configured to:
import or retrieve data from a database, the database comprising resource transmission data posted to accounts known to have been accessed by an unintended user;
process the database to develop one or more projected patterns of unintended user resource transmission;
import resource transmission data associated with a first user;
identify suspect patterns within the resource transmission data associated with a first user; and
execute a detection action in response to identification of suspect patterns within the resource transmission data associated with a first user.

12. The computer program product for detecting changes in resource transmission data associated with a first user of claim 11, wherein the steps of importing resource transmission data associated with a first user, identifying suspect patterns within the resource transmission data associated with a first user, and executing a detection action may be repeated one or more times.

13. The computer program product for detecting changes in resource transmission data associated with a first user of claim 12, wherein the detection action changes when the steps are repeated.

14. The computer program product for detecting changes in resource transmission data associated with a first user of claim 11, wherein the resource transmission data associated with a first user is imported from one or more user resource accounts.

15. The computer program product for detecting changes in resource transmission data associated with a first user of claim 11, wherein the detection action comprises:
identifying a current activity associated with a resource transmission of the first user;
analyzing the current activity to determine if the current activity is associated with a suspect pattern; and
in response, transmitting a signal to a user device or entity device to cause it to block or modify the current activity prior to completion.

16. The computer program product for detecting changes in resource transmission data associated with a first user of claim 11, wherein the detection action comprises:
identifying a current activity associated with a resource of the first user;
analyzing the current activity to determine if the current activity is associated with a suspect pattern; and
in response, notifying a user or institution associated with the user's account.

17. The computer program product for detecting changes in resource transmission data associated with a first user of claim 11, wherein the processing device is further configured to execute the computer-readable program code to:
accept a user input; and
execute a user-initiated action.

18. A computer-implemented method for detecting changes in resource transmission data associated with a first user, the method comprising:
providing a computing system comprising a computer processing device and a non-transitory computer readable medium, where the computer readable medium comprises configured computer program instruction code, such that when said instruction code is operated by said computer processing device, said computer processing device performs the following operations:
import or retrieve data from a database, the database comprising resource transmission data posted to accounts known to have been accessed by an unintended user;
process the database to develop one or more projected patterns of unintended user resource transmission;
import resource transmission data associated with a first user;
identify suspect patterns within the resource transmission data associated with a first user; and
execute a detection action in response to identification of suspect patterns within the resource transmission data associated with a first user.

19. The computer-implemented method of claim 16, wherein the steps of importing resource transmission data associated with a first user, identifying suspect patterns within the resource transmission data associated with a first user, and executing a detection may be repeated one or more times.

20. The computer-implemented method of claim 16, wherein the processing device is further configured to execute the computer-readable program code to:
accept a user input; and
execute a user-initiated action.
